(19) United States
(12) Patent Application Publication
(10) Pub. No.: US 2026/0079342 A1
(43) Pub. Date: Mar. 19, 2026

(54) Head-Mounted Device with Gaze Trackers

(71) Applicant: Apple Inc., Cupertino, CA (US)

(72) Inventors: Ivan S Maric, Campbell, CA (US); Blake N Trekell, San Francisco, CA (US); Marinus Meursing, Poway, CA (US); Guy Sarussi, Hadera (IL); Ryan Springer, San Francisco, CA (US); Martin Haller, Mountain View, CA (US); Shaw Chien Wu, Campbell, CA (US); Elad Oved, Kiryat Tivon (IL); Omer Elgressy, Herzliya (IL); Tomi P Maila, San Jose, CA (US); Sergii Podryga, Nassau (DE)

(21) Appl. No.: 19/272,346

(22) Filed: Jul. 17, 2025

Related U.S. Application Data
(60) Provisional application No. 63/696,075, filed on Sep. 18, 2024.

(51) Int. Cl. G02B 27/00; G02B 27/01

(52) U.S. Cl. CPC G02B 27/0093; G02B 27/0172; G02B 27/0176

(57) ABSTRACT

A head-mounted device may have left-eye and right-eye optical modules, each of which includes a lens barrel/support, a gaze tracker in the lens barrel, a display coupled to the lens barrel, and a plurality of lenses in the lens barrel that provide an image from the display to a corresponding eye box. The gaze tracker may include light emitters mounted on a printed circuit and light detectors. Each of the lenses may include a peripheral edge that defines a footprint that entirely overlaps a footprint of the printed circuit. The display may be mounted in a display bezel, and the display bezel may include recesses in which the light emitters are mounted. The recesses may be chamfered to increase the signal-to-noise ratio (SNR) of the gaze tracker.

Alternatively or additionally, a lens and/or a reflector may overlap the light emitters to increase the SNR of the gaze tracker.

This application claims the benefit of U.S. provisional Ser. No. 63/696,075, filed Sep. 18, 2024, which is hereby incorporated by reference herein in its entirety.

### FIELD

This relates generally to electronic devices, including wearable electronic devices such as head-mounted devices.

### BACKGROUND

Electronic devices such as head-mounted devices may have displays for displaying images. The displays may be housed in optical modules. A user may view the displayed images while a head-mounted device is being worn on the user's head.

### SUMMARY

A head-mounted device may have left-eye and right-eye optical modules. Each optical module in a head-mounted device may have a display that creates an image and corresponding lenses that provide the image to an associated eye box for viewing by a user. The optical modules may each include a lens barrel in which the display and lenses of that optical module are mounted. The optical modules may also each include a gaze tracker.

The gaze tracker in each optical module may include light emitters that emit light to create glints on a user's eye and light detectors that detect the light and determine the gaze of the user. The light emitters may be mounted on a printed circuit that surrounds the display. Each of the lenses may include a peripheral edge that defines a lens footprint that entirely overlaps a footprint of the printed circuit.

The display may be mounted in a display bezel, and the display bezel may include recesses in which the light emitters are mounted. The recesses may be chamfered allow light from the light emitters to pass unimpeded and increase the signal-to-noise ratio (SNR) of the gaze tracker. Alternatively or additionally, a lens and/or a reflector may overlap the light emitters to increase the amount of light directed out of the display bezel and increase the SNR of the gaze tracker.

### BRIEF DESCRIPTION OF THE DRAWINGS

FIG. 1 is a top view of an illustrative head-mounted device in accordance with some embodiments.

FIG. 2 is a rear view of an illustrative head-mounted device in accordance with some embodiments.

FIG. 3 is a schematic diagram of an illustrative electronic device in accordance with some embodiments.

FIG. 4 is a cross-sectional side view of an illustrative optical module with a gaze tracker in accordance with some embodiments.

FIG. 5 is a side view of illustrative multiple lenses that overlap light emitters of a gaze tracker in accordance with some embodiments.

FIGS. 6A and 6B are front views of illustrative multiple lenses with lens footprints that entirely overlap a footprint of a printed circuit on which light emitters of a gaze tracker are mounted in accordance with some embodiments.

FIG. 7 is a side view of a lens with a footprint that overlaps fields-of-view of multiple light emitters in accordance with some embodiments.

FIG. 8 is a perspective view of an illustrative display bezel with a plurality of recesses that house light emitters of a gaze tracking system in accordance with some embodiments.

FIGS. 9A-9D are illustrative diagrams of recesses in a display bezel with chamfers in accordance with some embodiments.

FIGS. 10A-10C are illustrative diagrams of a display bezel with a lens that overlaps a light emitter in accordance with some embodiments.

FIGS. 11A and 11B are illustrative side views of a display bezel with a reflector that overlaps a light emitter in accordance with some embodiments.

### DETAILED DESCRIPTION

An electronic device such as a head-mounted device may have a front face that faces away from a user's head and may have an opposing rear face that faces the user's head. Optical modules on the rear face may be used to provide images to a user's eyes. For example, a display in a display bezel may emit the images through the optical modules.

To monitor the eyes of a user, the electronic device may be provided with eye monitoring components, such as a gaze tracker, in the display bezel of each optical module. The gaze tracker may include light emitters and light detectors. The light emitters may illuminate the user's eyes so that the light detectors can detect the light reflected from the user's eye and track the user's gaze. In an illustrative configuration, the light emitters of each optical module include multiple discrete light sources such as light-emitting diodes, and the light detectors include multiple cameras. The light-emitting diodes may create glints on the user's eyes and can illuminate the user's pupils and irises. The cameras can then monitor the positions of the glints and/or the shapes of the user's pupils to determine the direction of gaze of the user. The cameras can also capture images of the user's irises (e.g., for biometric authentication).

The gaze tracker may operate through lenses in the optical module. To improve the signal-to-noise ratio (SNR) of the gaze tracker, the lenses may have an increased lens footprint. For example, the lenses may be sized with a lens footprint that entirely overlaps the light emitters and/or light detectors of the gaze trackers. Alternatively or additionally, the display bezel may include chamfered recesses for the light emitters to improve the SNR of the gaze trackers (e.g., by allowing more light from the light emitters to pass out of the display bezel to the user's eye).

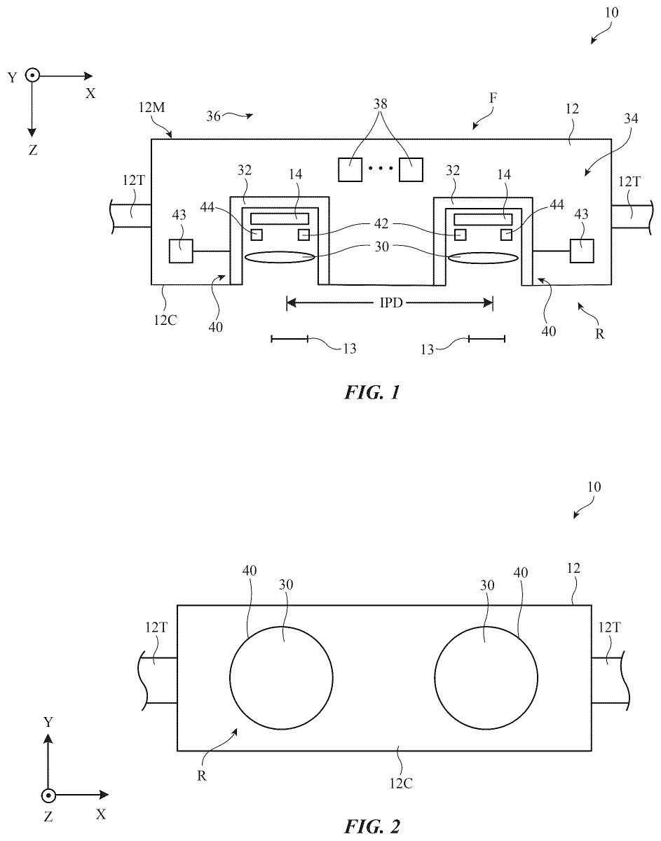

A top view of an illustrative head-mounted device that may include gaze trackers is shown in FIG. 1. As shown in FIG. 1, head-mounted devices such as electronic device 10 may have head-mounted support structures such as housing 12. Housing 12 may include portions (e.g., support structures 12T) to allow device 10 to be worn on a user's head. Support structures 12T may be formed from fabric, polymer, metal, and/or other material. Support structures 12T may form one or more straps (e.g., headbands) or other head-mounted support structures to help support device 10 on a user's head. A main support structure (e.g., main housing portion 12M) of housing 12 may support electronic components such as displays 14. Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures and these rigid walls may optionally be covered with electrical components, fabric, leather, or other soft materials, etc. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, a hat, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have left and right optical modules 40. Each optical module may include a respective display 14, lens 30, and support structure 32. Support structures 32, which may sometimes be referred to as lens barrels, supports, or optical module support structures, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images.

Lenses 30 may include one or more individual lenses (e.g., lens elements) for providing image light from displays 14 to respective eyes boxes 13. Lenses may be implemented using refractive glass lens elements, using mirror lens structures (catadioptric lenses), using Fresnel lenses, using holographic lenses, and/or other lens systems.

When a user's eyes are located in eye boxes 13, displays (display panels) 14 operate together to form a display for device 10 (e.g., the images provided by respective left and right optical modules 40 may be viewed by the user's eyes in first and second eye boxes 13 so that a stereoscopic image is created for the user). The left image from the left optical module fuses with the right image from a right optical module while the display is viewed by the user.

Although not shown in FIG. 1, front face F may also include one or more displays. In some embodiments, front face F may include an outwardly facing display that is viewable by viewers at exterior 36. The outwardly facing display may communicate information regarding the user of device 10 and/or the status of device 10 to the viewers at exterior 36.

It may be desirable to monitor the user's eyes while the user's eyes are located in eye boxes 13. For example, it may be desirable to track the user's eyes using one or more gaze trackers. Gaze tracking information may be used as a form of user input and/or may be used to determine where, within an image, image content resolution should be locally enhanced in a foveated imaging system. Therefore, each optical module 40 may be provided with a gaze tracker, which may include one or more light emitters, such as light emitters 44, and one or more light detectors, such as light detectors 42. In some embodiments, light emitter 44 may be light-emitting diodes, such as laser, lamps, or other light emitters, and light detector 42 may be a camera. Although FIG. 1 shows a single light emitter 44 and a single light detector 42 in each optical module 40, this is merely illustrative. In general, a gaze tracker in each optical module 40 may include any desired number of light emitters 44 and light detectors 42.

Light detectors 42 and light emitters 44 may operate at any suitable wavelengths (visible, infrared, and/or ultraviolet). With an illustrative configuration, which may sometimes be described herein as an example, light emitters 44 emit infrared light that is invisible (or nearly invisible) to the user. This allows eye monitoring operations to be performed continuously without interfering with the user's ability to view images on displays 14.

Not all users have the same interpupillary distance IPD. To provide device 10 with the ability to adjust the interpupillary spacing between modules 40 along lateral dimension X and thereby adjust the spacing IPD between eye boxes 13 to accommodate different user interpupillary distances, device 10 may be provided with actuators 43. Actuators 43 can be manually controlled and/or computer-controlled actuators (e.g., computer-controlled motors) for moving support structures 32 relative to each other. Information on the locations of the user's eyes may be gathered using, for example, light detectors 42. The locations of eye boxes 13 can then be adjusted accordingly.

As shown in FIG. 2, cover 12C may cover rear face R while leaving lenses 30 of optical modules 40 uncovered (e.g., cover 12C may have openings that are aligned with and receive modules 40). As modules 40 are moved relative to each other along dimension X to accommodate different interpupillary distances for different users, modules 40 move relative to fixed housing structures such as the walls of main portion 12M and move relative to each other.

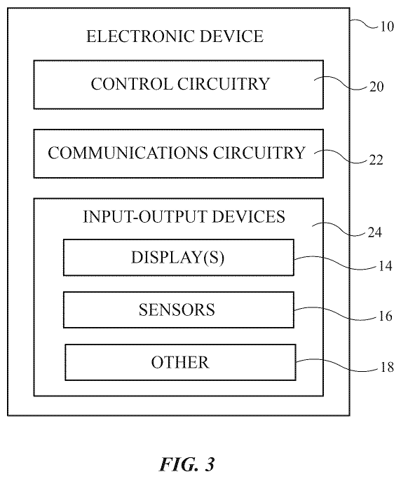

A schematic diagram of an illustrative electronic device such as a head-mounted device or other wearable device is shown in FIG. 3. Device 10 of FIG. 3 may be operated as a stand-alone device and/or the resources of device 10 may be used to communicate with external electronic equipment. As an example, communications circuitry in device 10 may be used to transmit user input information, sensor information, and/or other information to external electronic devices (e.g., wirelessly or via wired connections). Each of these external devices may include components of the type shown by device 10 of FIG. 3.

As shown in FIG. 3, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, may be a portion of control circuitry 20, may be coupled to control circuitry 20, and/or may form combined control and communications circuitry. Circuitry 22 may support bidirectional wireless communications between device 10 and external equipment (e.g., a companion device such as a computer, cellular telephone, or other electronic device, an accessory such as a point device, computer stylus, or other input device, speakers or other output devices, etc.) over a wireless link. For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a wireless link operating at a frequency between 2 GHz and 2.5 GHz (e.g., 2.4 GHz), between 4 GHz and 7 GHz (e.g., 5 GHz or 6 GHz), between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as input-output devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microleds), and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light source such as light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

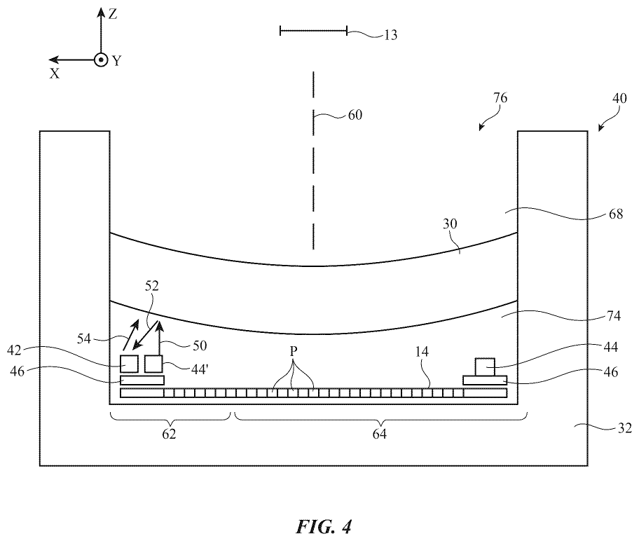

A cross-sectional side view of an illustrative optical module for device 10 is shown in FIG. 4. As shown in FIG. 4, optical module 40 may have lens barrel 32 (also referred to as support structure 32 and/or support 32 herein). Lens 30 (which may include one or more individual lenses/lens elements) may be used to provide an image from pixels P of display 14 to eye box 13 along optical axis 60. To track the gaze of a user's eye in eye box 13, optical module 40 may include one or more gaze trackers that includes one or more light emitters, such as light emitters 44, and one or more light detectors, such as light detectors 42. Light emitters 44 may be, for example, light-emitting diodes, lasers, lamps, or other illumination sources that emit light toward eye box 13. Light detectors 42 may be, for example, cameras, photodiodes, other light detectors that determine the gaze of the user by measuring reflected emitted light (e.g., light from light emitters 44 that has reflected from the user's eye). In particular, light detectors 42 may operate in direction 54 to measure the user's gaze. Additionally or alternatively, light detectors 42 may include one or more cameras that may capture images of the user's eye while the user's eye is located in eye box 13.

Light emitters 44 may emit light at one or more wavelengths of interest (e.g., visible light wavelengths and/or infrared light wavelengths, etc.) and light detectors 42 may be sensitive at these wavelengths (e.g., visible light wavelengths and/or infrared light wavelengths, etc.). In an illustrative configuration, light emitters 44 emit infrared light (e.g., light with a wavelength between 780 nm and 1 mm, between 760 nm and 1400 nm, or another suitable infrared range). The infrared light may be used to illuminate the user's eye in eye box 13 while being unnoticeable (or nearly unnoticeable) to the user (e.g., because human vision is not generally sensitive to infrared light except when the infrared light has an infrared wavelength near the edge of the visible light spectrum, which extends from 380 to 740 nm).

Electronic components in module 40 such as display 14, light detectors 42, and light emitters 44 may be coupled to one or more printed circuits or other substrates containing metal traces. For example, light emitters 44 may be mounted on a printed circuit, such as a flexible printed circuit, a rigid printed circuit board, or a printed circuit with rigid and flexible portions. The metal traces may form interconnect paths that carry power signals, data signals, and control signals. As shown in FIG. 4, for example, light emitters 44 may be mounted on a ring-shaped substrate such as flexible printed circuit 46. Printed circuit 46 and light emitters 44 may extend around some or all of the inner periphery of support 32 (and therefore around some or all of the outer periphery of display 14). Similarly, light detectors 42 may extend around some or all of the inner periphery of support 32, if desired.

During operation, light from light emitters 44 that are mounted along the edge of display 14 may travel to eye box 13 through lens 30. Light emitters 44 are generally out of the user's field of view or nearly out of the user's field of view as the user is viewing images presented by the array of pixels P on display 14. Some of light emitters 44 (e.g., N light emitters 44, where N is at least 3, at least 4, at least 5, at least 6, 3-9, less than 15, less than 10, less than 7, less than 6, or other suitable number) may create reflections off of the surface of the user's eye in eye box 13. These reflections, which may sometimes be referred to as glints, can be captured by light detectors 42. Device 10 can process glint information obtained by light detectors 42 to track the user's gaze. For example, control circuitry 20 (FIG. 3) can analyze the positions of the glints to determine the shape of the user's eye (e.g., the user's cornea). From this information, control circuitry 20 can determine the direction of the user's gaze.

In addition to, or instead of, serving as glint light sources (e.g., light sources that produce glint illumination that is detected as discrete eye glints by light detectors 42), light from light emitters 44 may serve as blanket eye illumination. In particular, light from light emitters 44 may illuminate portions of each of the user's eyes such as the user's iris and the user's pupil.

During operation, light detectors 42, such as a camera in light detectors 42, may capture an image of the user's pupil as the pupil is being illuminated by light from light emitters 44. The user's pupil will have a shape (e.g., an oval shape) that varies depending on the orientation of the user's eye to light detectors 42. If, as an example, the eye is aligned with light detectors 42, the pupil will appear circular or nearly circular, whereas if the eye is angled away from light detectors 42, the pupil will have higher eccentricity. By analyzing the shape of the pupil, control circuitry 20 (FIG. 3) can determine the direction of the user's gaze.

It may also be desirable for light detectors 42, such as camera in light detectors 42, to capture other eye images such as images of the iris of the user's eye. Iris patterns are user-specific, so iris images may be used to authenticate users in device 10 (e.g., to log the user into a user account, to substitute for a username and/or password, or to otherwise serve as a biometric credential for device 10).

Pupil illumination and the illumination for the glints can be produced by light emitters 44 at the same wavelength or at different wavelengths. For example, pupil and glint illumination can be provided by light emitters 44 at a wavelength of 940 nm, 800-1000 nm, at least 800 nm, at least 1300 nm, at least 850 nm, at least 900 nm, at least 950 nm, less than 950 nm, or other suitable wavelength. Configurations in which the wavelength of the glint and pupil illumination is sufficiently long to be invisible to most or all users may help allow glint and pupil measurements and/or other gaze tracking measurements to be taken continuously during operation of device 10, without potentially distracting users. Iris illumination may be provided by light emitters 44 at the same wavelength and/or a different wavelength than the glint illumination and the pupil illumination. To obtain desired image contrast when gathering iris information, it may be desirable for iris illumination to be provided at a shorter wavelength than the pupil and glint illumination (e.g., at a visible light wavelength and/or at a shorter infrared wavelength than used by light emitters 44 when providing gaze tracking illumination). Light detectors 42 may include one or more cameras (e.g., image sensors) or other detectors that capture pupil image data, glint image data, and iris image data, and/or multiple cameras may be provided each of which captures image data at a different wavelength (or band of wavelengths).

Consider, as an example, a scenario in which light detectors 42 are sensitive to infrared light over a range of wavelengths (e.g., one or more wavelengths between 780 nm and 1000 nm or other suitable wavelength range). Light emitters 44 may emit light at multiple wavelengths. For example, light emitters 44 may contain a first set of light emitters that produce illumination at a first wavelength (e.g., 850 nm, a wavelength between 780 and 870 nm, a wavelength of less than 900 nm, etc.) and may contain a separate second set of light emitters that produce illumination at a second wavelength (e.g., a second wavelength that is greater than the first wavelength such as a wavelength of 940 nm, at least 900 nm, 890-1000 nm, etc.). In this type of arrangement, the first set of light emitters may be used when device 10 is initially started up (e.g., to help light detectors 42 capture high-contrast iris images or other eye images for authentication), whereas the second set of light emitters may be operated later, during normal operation, to track the user's gaze. To avoid the possibility of the iris illumination being noticed by a user (e.g., a user who happens to be sensitive to near infrared light just past the edge of the visible light spectrum), the first set of light emitters may be turned off during normal operation. If desired, iris illumination may be provided in the visible light spectrum in addition to or instead of using infrared iris illumination.

It is possible that light from light emitters 44 can exhibit undesired reflections from the surface of lens 30 facing display 14. For example, if a light emitter is located adjacent to one or more light detectors 42, there is a possibility that an emitted light ray will follow path 50 to lens 30 and, upon directly reflecting from the surface of lens 30, will follow path 52 to light detector 42. This direct reflection of the output of the light emitter from the inner surface of lens 30 to light detector 42 may be too strong and may overwhelm light detector 42 and/or may otherwise interfere with the ability of light detector 42 to capture a clear image of the glints on the user's eye and/or the user's pupil shape. To prevent this possibility, it may be desirable to mount light emitters 44 on flexible printed circuit 46 only in areas of barrel 32 such as region 64 that are located away from light detector 42 and not in areas of barrel 32 such as region 62 that are adjacent to light detector 42 (e.g., within 5 mm of light detector 42, within 1 cm of light detector 42, within 2 cm of light detector 42, or within other suitable close distance to light detector 42 that creates direct lens reflections detected by light detector 42). However, this is merely illustrative. In some embodiments, light detectors 42 and light emitters 44 may be mounted in support structure 32 adjacent to one another.

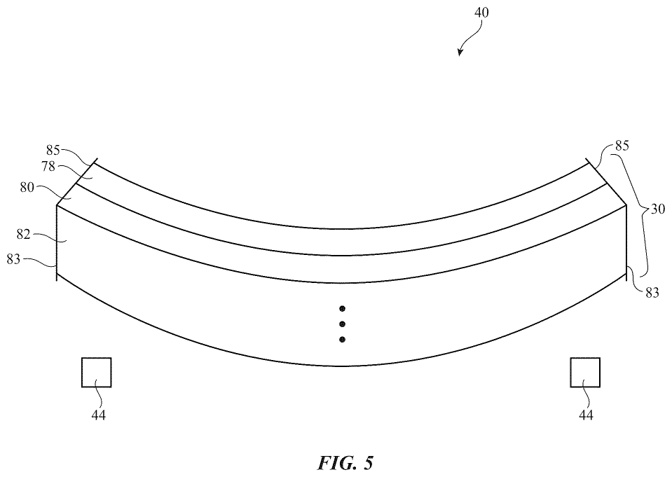

Lens 30 of module 40 may include multiple lenses (e.g., lens elements). For example, lens 30 may be a catadioptric lens or other suitable lens that includes multiple lenses (e.g., multiple lens elements). An illustrative example is shown in FIG. 5.

As shown in FIG. 5, lens 30 of module 40 may include first lens 78 (also referred to as first lens element 78 herein), second lens 80 (also referred to as second lens element 80 herein), and third lens 82 (also referred to as third lens element 82 herein). Each of first lens 78, second lens 80, and third lens 82 may be formed from glass, polymer (e.g., polycarbonate), acrylic, sapphire, and/or any other suitable material.

Although not shown in FIG. 5 for clarity, lens 30 may also include adhesive layers, polarizer layers, mirror layers, and/or any other suitable layers between and/or on first lens 78, second lens 80, and/or third lens 82. Lens 30 may include additional lenses (or fewer lenses), if desired.

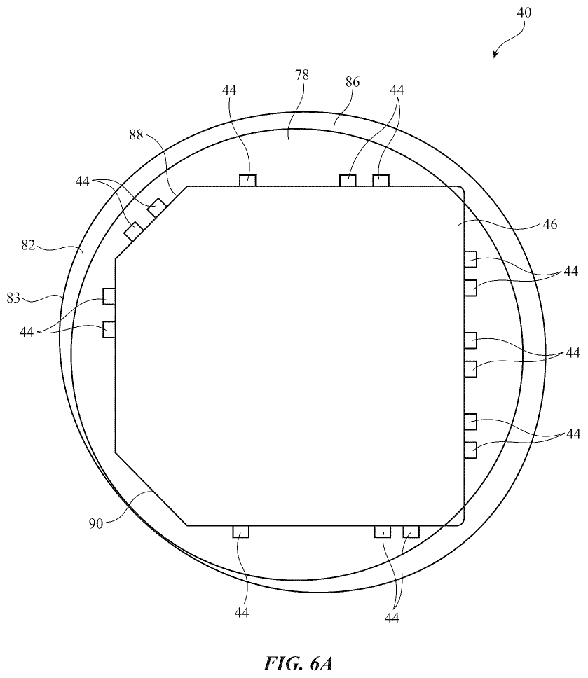

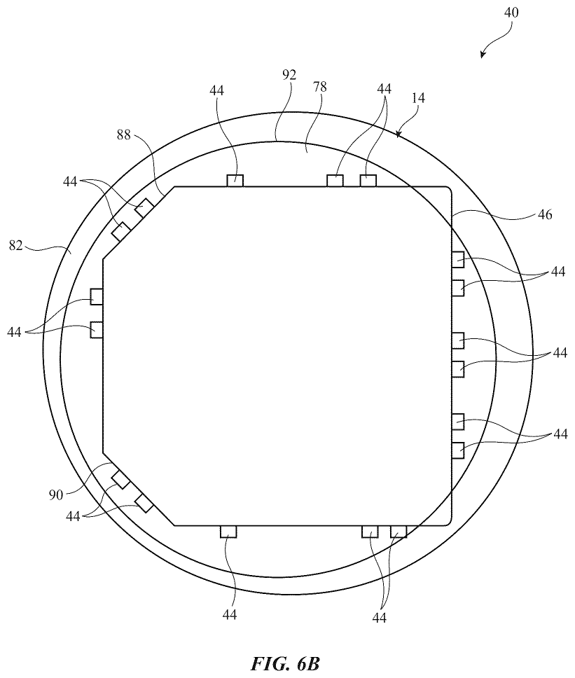

Light emitters 44 may be overlapped by lens 30. In particular, outermost edge 83 of lens 30, which corresponds to the outermost edge of lens 82 in the example of FIG. 5) may extend beyond light emitters 44. In other words, lens 82 may have a lens footprint that entirely overlap light emitters 44. However, due to the shapes of lenses 80 and 78, lens 80 and/or lens 78 may not overlap light emitters 44. In other words, each of lenses 78, 80, and 82 may have a different lens footprint. In the example of FIG. 5, lens 78 may have a given lens footprint that is the smallest lens footprint of the lenses in lens 30. In particular, lens 78 may have edge 85 that does not extend beyond light emitters 44. As a result, light emitted by light emitters 44 may be redirected away from a user's eye (e.g., by the edge 85). Therefore, it may be desirable to increase the lens footprint of one or more lenses in lens 30 and/or to decrease the footprint of light emitters 44 to ensure that all of the lenses in lens 30 entirely overlap light emitters 44. An illustrative example is shown in FIG. 6A.

As shown in FIG. 6A, light emitters 44 on printed circuit 46 may be overlapped by lenses 82 and 78 of optical module 40. Printed circuit 46 may be coiled/wound in a square or rectangular shape with rounded corners, a hexagonal shape, an octagonal shape, a circular shape, a square shape, or another suitable shape, and light emitters 44 may be side-firing light-emitting diodes (or top-filing light-emitting diodes) that are mounted on printed circuit 46. At least 3 LEDs, at least 5 LEDs, between 5 LEDs and 15 LEDs, at least 10 LEDs, less than 25 LEDs, or another suitable number of LEDs may be mounted on printed circuit 46.

To ensure that all of light emitters 44 are overlapped by all of the lenses in lens 30 (FIG. 5), one or more lenses in lens 30 may have an increased lens footprint. In the example of FIG. 6A, lens 78 may have edge 86 that defines a lens footprint that entirely overlaps light emitters 44. In other words, the lens footprint of lens 78 may encapsulate the footprint of light emitters 44. In this way, light emitters 44 may be entirely overlapped by all of the lenses in lens 30, and light from light emitters 44 may pass through lens 30 to the user's eye. Therefore, the SNR of light emitters 44 may be increased.

Alternatively or additionally, printed circuit 46 may be coiled/wound with one or more footprint chamfers, such as chamfer 88 and chamfer 90, that reduce the footprint of printed circuit 46. For example, some of light emitters 44 may be mounted on chamfer 88. By forming printed circuit 46 with at least 5 sides, at least 6 sides, at least 8 sides, or another suitable number of sides with one or more footprint chamfers, the footprint of light emitters 44 may be entirely overlapped by the footprint of all of the lenses in lenses 30. Therefore, the SNR of the gaze trackers that include light emitters 44 may be increased.

Although FIG. 6A shows edge 86 of lens 78 being extended to completely overlap light emitters 44, the lens footprint of lens 78 in FIG. 6A may extend significantly beyond the footprint of light emitters 44. In some embodiments, it may be desirable to match the lens footprint of lens 78 to the footprint of light emitters 44. An illustrative example is shown in FIG. 6B.

As shown in FIG. 6B, lens 78 may have edge 92 that defines a lens footprint that is matched to the footprint of light emitters 44 of printed circuit 46. In other words, the lens footprint of lens 78 (e.g., the smallest lens footprint of the lenses in lens 30) in the example of FIG. 6B may be smaller than the lens footprint of lens 78 in the example of FIG. 6A and may generally be just large enough (e.g., less than 1 mm greater than or less than 2 mm greater than, as examples) the footprint of light emitters 44 at its closes point(s). The shape of the footprint of lens 78 may match the footprint of light emitters 44. This may reduce the risk of stray light (e.g., light other than the light from light emitters 44 and display 14 (FIG. 4)) entering lens 30.

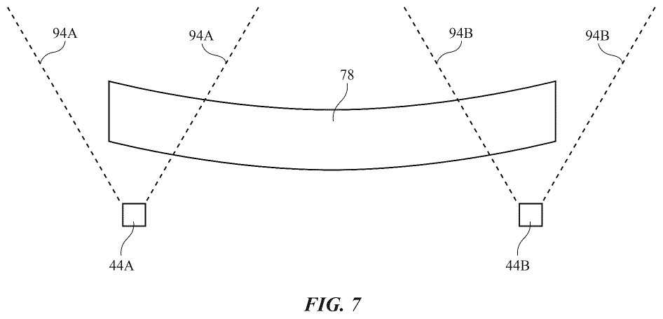

In general, the lens footprint of lenses in lens 30 (FIG. 5), such as lens 78, and the footprint of light emitters 44 on printed circuit 46 may be adjusted to ensure that the lens footprint of the lenses encapsulates the footprint of light emitters 44, while ensuring that the lens footprint of the lenses is not increased too much to allow stray light to enter lens 30. As shown in the illustrative example of FIG. 7, the footprint of light emitters 44A and 44B may be completely overlapped by lens 78. Therefore, field-of-view (FOV) 94A of light emitter 44A and FOV 94B of light emitter 44B may be at least mostly overlapped by lens 78. For example, at least 60%, at least 70%, at least 80%, or between 60% and 90%, as examples, of FOVs 94 may be overlapped by lens 78. In this way, the footprint light emitters 44 may be entirely overlapped by all of the lenses in lens 30, and a majority of light from light emitters 44 may pass through lens 30 to the user's eye. Therefore, the SNR of the gaze trackers that include light emitters 44 may be increased.

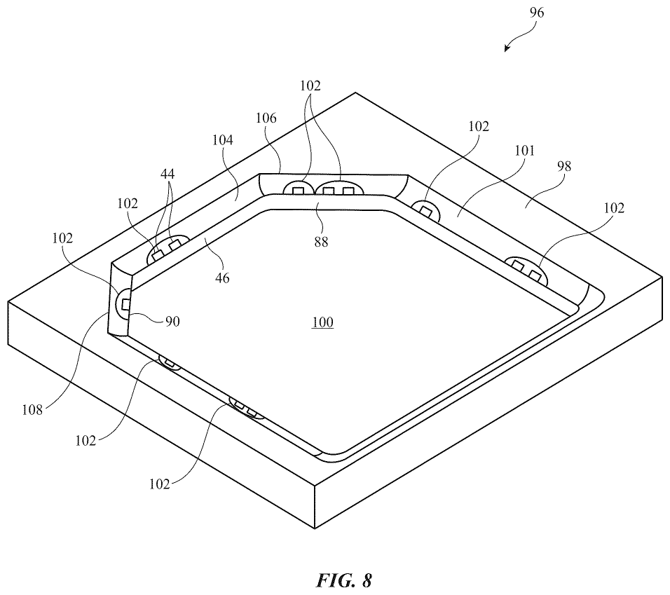

Light emitters 44 on printed circuit 46 may be mounted on a bezel (also referred to as a display bezel herein) that houses a display, such as display 14 (FIG. 4). An illustrative example of light emitters 44 on printed circuit 46 mounted on a display bezel is shown in FIG. 8.

As shown in FIG. 8, display bezel 96 may include housing 98. Housing 98 may be formed from metal, polymer, or any other suitable material. Housing 98 may have central region 100. Central region 100 may be an opening of housing 98 and may house a display, such as display 14 of FIG. 4, and display bezel 96 may be incorporated into an optical module, such as optical module 40 of FIG. 4.

Printed circuit 46 and light emitters 44 may be mounted to housing 98. In particular, printed circuit 46 and/or light emitters 44 may be attached to housing 98, such as using adhesive and/or fasteners. Printed circuit 46 may surround central region 100 and therefore may surround a display when the display is mounted in display bezel 96. In the example of FIG. 8, printed circuit 46 may have a surface on which light emitters 44 are mounted, and an opposite surface that faces central region 100 (and the display when mounted to bezel 96). In this configuration, light emitters 44 may be side-firing light emitters, such as side-firing LEDs. However, this is merely illustrative. In some embodiments, light emitters 44 may be side-firing LEDs that face central region 100. Alternatively, light emitters 44 may be top-firing LEDs that are parallel to or at an angle to a top surface of housing 98.

Regardless of the orientation of light emitters 44, housing 98 of bezel 96 may be shaped to accommodate light emitters 44 and printed circuit 46. For example, central region 100 may have peripheral edge 101 of the same shape (or nearly the same shape) as printed circuit 46. In particular, peripheral edge 101 may include footprint chamfers, such as chamfers 106 and 108 that accommodate the footprint chamfers of printed circuit 46, including chamfers 88 and 90, respectively. Alternatively or additionally, peripheral edge 101 may include recesses 102, and light emitters 44 may extend into recesses 102. In some embodiments, each light emitter 104 may be mounted in a given one of recesses 102. In other words, light emitters 44 may be housed in/mounted in recesses 102. In this way, printed circuit 46 and light emitters 44 may be supported and accommodated by housing 98.

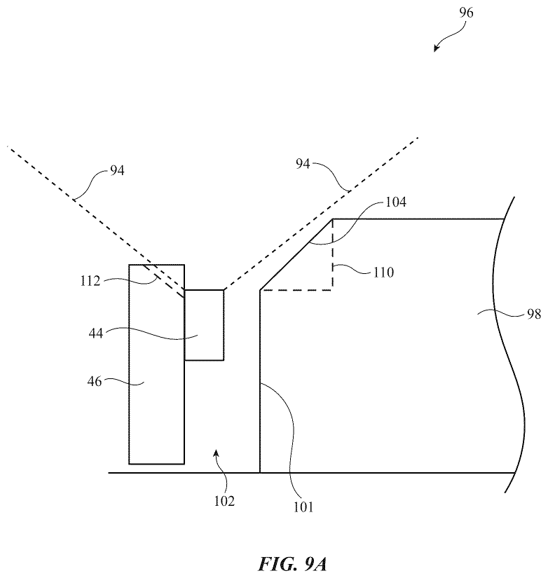

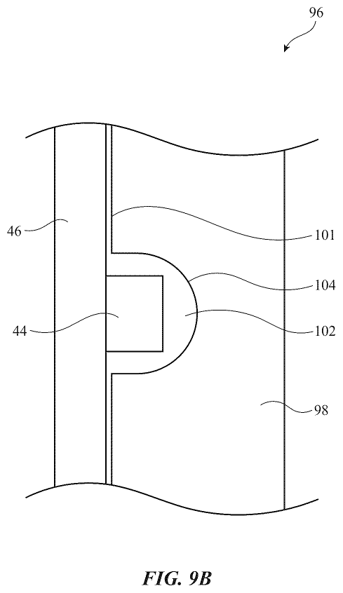

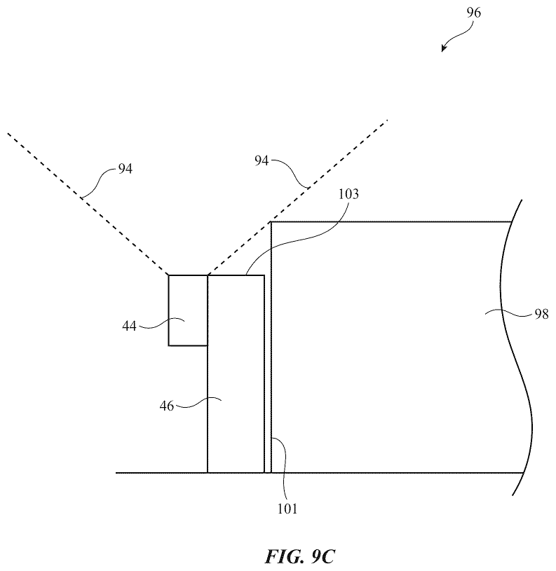

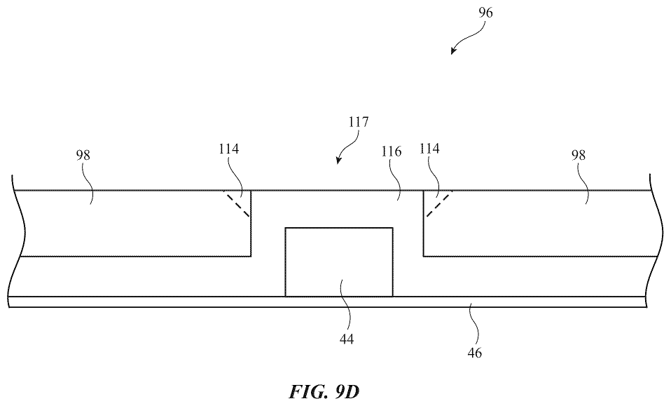

In some embodiments, peripheral edge 101 may include one or more edge chamfers, such as chamfers 104. Chamfers 104 may include along each segment of peripheral edge 101, may be present in each recess 102, or otherwise may be included on housing 98. Chamfers 104 may allow a higher percentage of light from light emitters 44 to pass out of bezel 96 and reach the user's eye, while reducing the required size of recesses 102. In this way, chamfers 104 may increase the SNR of light emitters 44. Illustrative examples of chamfers that may be incorporated into recesses 102 are shown in FIGS. 9A-9D.

As shown in FIG. 9A, light emitter 44 may face peripheral edge 101 of housing 98 of bezel 96 in recess 102. Light emitter 44 may be a side-firing light emitter, such as a side-firing light-emitting diode, with FOV 94.

Peripheral edge 101 may have an edge chamfer, such as chamfer 104, in one or more fo recesses 102. Chamfer 104 may be a chamfer of at least 25°, at least 35°, at least 45°, or another suitable angle. Chamfer 104 may allow light emitted by light emitter 44 to pass unimpeded. In other words, chamfer 104 may allow all of the light, at least 95% of the light, at least 90% of the light, at least 80% of the light, or another suitable amount of the light in FOV 94 to pass. As shown in FIG. 9A for example, chamfer 104 may be angled to allow the portion of light in FOV 94 that would otherwise be blocked by peripheral edge 101 to pass.

As an alternative to including chamfer 104 on peripheral edge 101, a notch, such as notch 110 may be formed in peripheral edge 101 in one or more of recesses 102. Notch 110 may similarly allow the portion of light in FOV 94 that would otherwise be blocked by peripheral edge 101 to pass.

Alternatively or additionally to forming chamfer 104 in peripheral edge 101 of housing 98, printed circuit 46 may be modified to allow additional light form light emitter 44 to pass. For example, as shown in FIG. 9A, printed circuit 46 may have a printed circuit chamfer, such as chamfer 112 in one or more recesses 102. Chamfer 112 may be a chamfer of at least 25°, at least 35°, at least 45°, or another suitable angle. Chamfer 112 may allow light emitted by light emitter 44 to pass unimpeded. In other words, chamfer 112 may allow all of the light, at least 95% of the light, at least 90% of the light, at least 80% of the light, or another suitable amount of the light in FOV 94 to pass. As shown in FIG. 9A for example, chamfer 112 may be angled to allow the portion of light in FOV 94 that would otherwise be blocked by printed circuit 46 to pass.

As an alternative to including chamfer 112 on printed circuit 46, a notch (e.g., a notch similar to notch 110) may be formed in printed circuit 46. The notch may similarly allow the portion of light in FOV 94 that would otherwise be blocked by printed circuit 46 to pass.

By including a notch or chamfer on housing 98 and/or printed circuit 46, more light from light emitter 44 may pass out of bezel 96 to a user's eyes. In this way, the SNR of the gaze tracker that includes light emitter 44 may be increased.

Chamfer 104 may be present on one or more sides of light emitter 44 to increase the amount of light that passes from light emitter 44 unimpeded. As shown in the illustrative top view of FIG. 9B, chamfer 104 may be formed along an entire edge of recess 102 and may surround three sides of light emitter 44. However, this is merely illustrative. In general, one or more edge chamfers on edge 101 of housing 98, such as chamfer 104, may be present on one side of light emitter 44, two sides of light emitter 44, or three sides of light emitter 44.

Instead of, or in addition to, including a chamfer or notch in printed circuit 46 and/or in peripheral edge 101, light emitter 44 may be positioned on printed circuit 46 to increase the amount of light that will exit bezel 96 unimpeded. An illustrative example is shown in FIG. 9C.

As shown in FIG. 9C, light emitter 44 may be aligned with edge 103 of printed circuit 46. Therefore, light from light emitter 44 in FOV 94, such as all of the light, at least 95% of the light, at least 90% of the light, at least 80% of the light, or another suitable amount of the light in FOV 94, may pass out of bezel 96 unimpeded, which may increase the SNR of a gaze tracker that includes light emitter 44.

In the example of FIG. 9C, light emitter 44 faces away from housing 98. In other words, light emitter 44 may face central region 100 (FIG. 8). However, this is merely illustrative. In some embodiments, a light emitter facing housing 98 (such as light emitter 44 of FIG. 9A) may be aligned with an edge of printed circuit 46.

Moreover, although FIGS. 9A-9C have shown light emitters 44 as side-firing light emitters, this is merely illustrative. In some embodiments, a top-firing light emitter may be included in bezel 96, and housing 98 may be modified to improve the SNR of the gaze tracker that includes the top-firing light emitter. An illustrative example is shown in FIG. 9D.

As shown in FIG. 9D, light emitter 44 may be a top-firing LED that operates through opening 117 in housing 98 of bezel 96. Housing 98 may include optional chamfer 114 that allows light from light emitter 44, such as all of the light, at least 95% of the light, at least 90% of the light, at least 80% of the light, or another suitable amount of the light from light emitter 44, to pass out of bezel 96 unimpeded.

If desired, adhesive 116, which may be an optically-clear adhesive or an adhesive transparent to infrared wavelengths emitted by light emitter 44, may attach light emitter 44 and/or printed circuit 46 to housing 98.

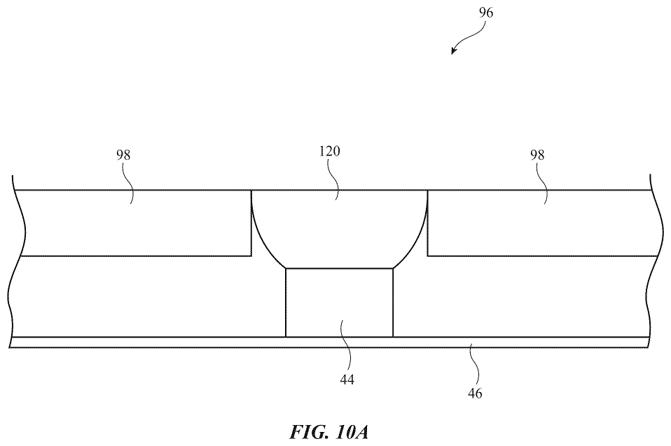

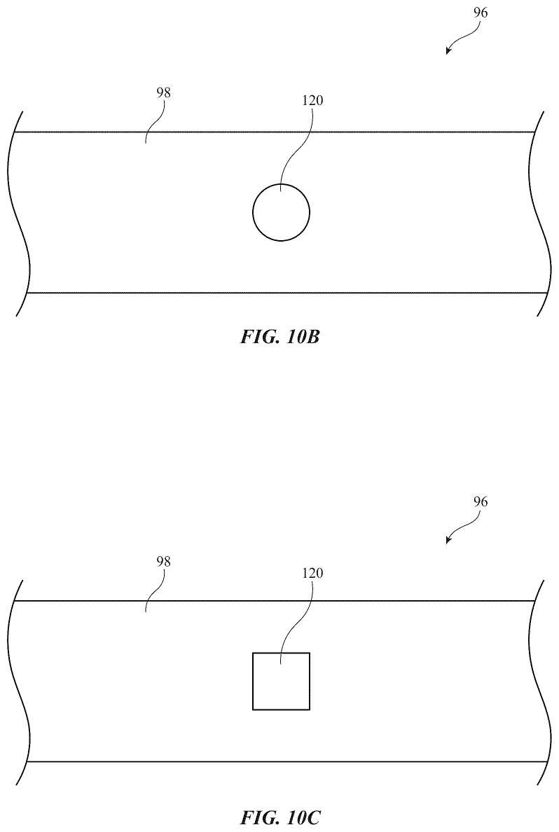

Regardless of whether light emitters 44 are side-firing or top-firing emitters, lenses and/or reflectors may be incorporated into display bezel 96 overlapping light emitters 44. An illustrative example of a lens overlapping a light emitter is shown in FIG. 10A.

As shown in FIG. 10A, bezel 96 may include lens 120 overlapping light emitter 44. Lens 120 may be formed from polymer, glass, acrylic, polycarbonate, or another suitable material. Light emitted by light emitter 44 may be directed by lens 120 out of housing 98 and therefore out of bezel 96. Lens 120 may have any suitable shape. For example, as shown in the illustrative top view of FIG. 10B, lens 120 may have a circular shape. Alternatively, as shown in the illustrative top view of FIG. 10C, lens 120 may have a square or rectangular shape. In general, by incorporating lens 120 over light emitter 44, more light from light emitter 44 may pass out of housing 98 of bezel 96 unimpeded, and may therefore increase the SNR of a gaze tracker that includes light emitter 44.

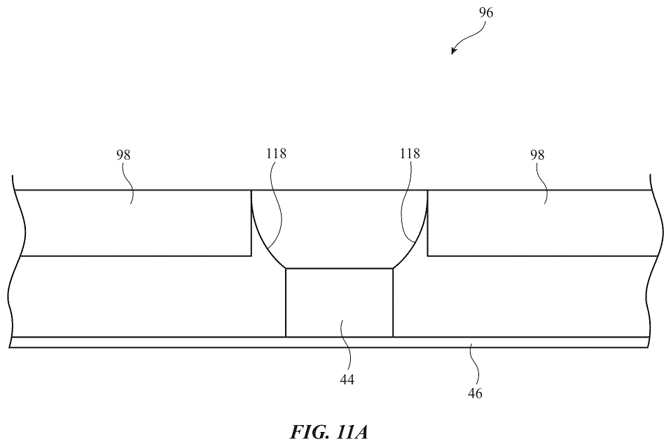

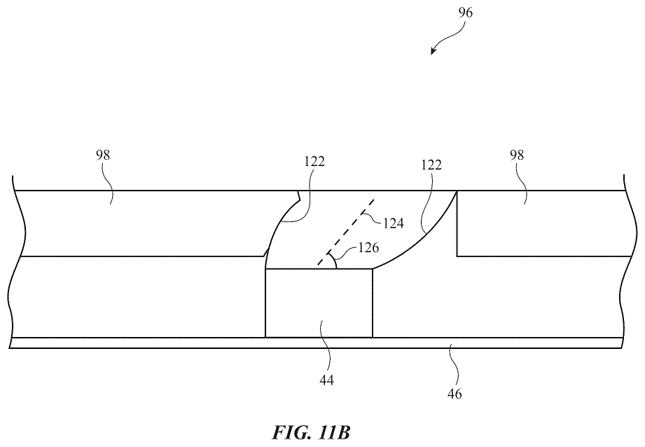

Alternatively or additionally to including lens 120, a bezel 96 may include reflectors that overlap the light emitters. An illustrative example is shown in FIG. 11A.

As shown in FIG. 11A, reflector 118 may be included over light emitter 44. Reflector 118 may be, for example, a metal reflector, a polymer (e.g., a white polymer or a thin-film interference filter) reflector, or a reflector formed from another suitable material. Reflector 118 may be a conical reflector, a parabolic reflector, or a reflector of another suitable shape. In general, by incorporating reflector 118 over light emitter 44, more light from light emitter 44 may pass out of housing 98 of bezel 96 unimpeded, and may therefore increase the SNR of a gaze tracker that includes light emitter 44.

In some embodiments, a reflector may be angled relative to light emitter 44. An illustrative example is shown in FIG. 11B.

As shown in FIG. 11B, reflector 122 may overlap light emitter 44. Reflector 122 may be, for example, a metal reflector, a polymer (e.g., a white polymer or a thin-film interference filter) reflector, or a reflector formed from another suitable material. Reflector 122 may be a conical reflector, a parabolic reflector, or a reflector of another suitable shape.

Reflector 122 may be angled relative to light emitter 44. For example, central axis 124 of reflector 122 may be offset from a top surface of light emitter 44 by angle 126 of less than 90°, such as less than 80°, less than 70°, or between 30° and 75°, as examples. Alternatively, angle 126 may be greater than 90°, such as at least 95°, at least 100°, at least 130°, between 110° and 160°, or another suitable angle. By angling reflector 122 relative to light emitter 44, light from light emitter 44 may be directed out of bezel 96 in a suitable direction to increase the SNR of a gaze tracker associated with light emitter 44.

In general, a lens, such as lens 120 (FIG. 10), and/or a reflector, such as reflector 118/122 (FIG. 11) may overlap each of the light emitters in a gaze tracker.

Although FIGS. 10-11 have shown lens 120 and/or reflector 118 overlapping a top-firing emitter 44, this is merely illustrative. In some embodiments, lens 120 and/or reflector 118 may overlap a side-firing light emitter.

In the examples of FIGS. 9-11, light emitters 44 are shown as emitting light perpendicularly relative to a top surface of bezel 96. However, this is merely illustrative. In some embodiments, light emitters 44 may be mounted to bezel 96 at an angle, which may increase the amount of light that exits bezel 96 and increase the SNR of a gaze tracker associated with light emitters 44.

Although FIGS. 8-11 have shown light emitters 44 on printed circuit 46 attached to/mounted on bezel 96, this is merely illustrative. In some embodiments, light emitters 44 on printed circuit 46 may be attached to a support structure/lens barrel, such as support structure 32 of FIG. 1. For example, bezel 96 may be integrated with support structure 32, and light emitters 44 on printed circuit and/or a display may be mounted to support structure 32. Alternatively, light emitters 44 on printed circuit 46 may be mounted to support structure 32, and a separate display bezel may be mounted in support structure 32 to support a display. In general, light emitters 44 on printed circuit 46 may be mounted on any suitable portion of an optical module in a head-mounted device.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device, comprising:
a housing; and
optical modules supported by the housing and configured to provide images respectively to first and second eye boxes, wherein each of the optical modules comprises:
a support structure,
a gaze tracker in the support structure, wherein the gaze tracker comprises light emitters mounted on a printed circuit and light detectors,
a display coupled to the support structure, and
a plurality of lenses in the support structure that provide an image from the display to a corresponding eye box, wherein each of the lenses comprises a peripheral edge that defines a lens footprint that entirely overlaps a footprint of the light emitters on the printed circuit.

2. The head-mounted device of claim 1, wherein each lens of the plurality of lenses has a different lens footprint.

3. The head-mounted device of claim 2, wherein a given lens of the plurality of lenses has a given lens footprint that is a smallest lens footprint of the plurality of lenses, and the given lens footprint has a shape that corresponds with the footprint of the light emitters on the printed circuit.

4. The head-mounted device of claim 3, wherein the printed circuit is wrapped with rounded corners.

5. The head-mounted device of claim 3, wherein each of the light emitters has a field-of-view, and the given lens footprint overlaps at least 60% of the field-of-view of each of the light emitters.

6. The head-mounted device of claim 1, wherein each of the optical modules further comprises:
a display bezel, wherein the display is mounted in the display bezel, and the printed circuit with the light emitters is coupled to the display bezel.

7. The head-mounted device of claim 6, wherein the display bezel comprises a plurality of recesses, and each of the light emitters is mounted in a given one of the plurality of recesses.

8. The head-mounted device of claim 7, wherein the display bezel has a peripheral edge, and the peripheral edge of the display bezel has a chamfer in each of the recesses.

9. The head-mounted device of claim 7, wherein the display bezel has a peripheral edge, and the peripheral edge of the display bezel has a notch in each of the recesses.

10. The head-mounted device of claim 7, wherein the printed circuit comprises a chamfer in each of the recesses.

11. The head-mounted device of claim 6, wherein the display bezel further includes a lens that overlaps each of the light emitters.

12. The head-mounted device of claim 6, wherein the display bezel further includes a reflector that overlaps each of the light emitters.

13. A head-mounted device, comprising:
a housing; and
optical modules supported by the housing and configured to provide images respectively to first and second eye boxes, wherein each optical module comprises:
a lens barrel,
a display bezel in the lens barrel, wherein the display bezel comprises a central region and a plurality of recesses with edge chamfers surrounding the central region,
a display mounted in the display bezel, and
a gaze tracker in the lens barrel, wherein the gaze tracker comprises light emitters mounted on a printed circuit and light detectors, and each of the light emitters is mounted in a given one of the plurality of recesses.

14. The head-mounted device of claim 13, wherein the printed circuit includes a printed circuit chamfer in each of the recesses.

15. The head-mounted device of claim 13, wherein the light emitters comprise side-firing light-emitting diodes.

16. The head-mounted device of claim 13, wherein the light emitters comprise top-firing light-emitting diodes.

17. The head-mounted device of claim 13, wherein the display bezel further includes lenses that each overlaps a respective one of the light emitters.

18. The head-mounted device of claim 13, wherein the display bezel further includes reflectors that each overlaps a respective one of the light emitters.

19. The head-mounted device of claim 18, wherein at least one of the reflectors is angled relative to the respective one of the light emitters.

20. An optical module for a head-mounted device, the optical module comprising:
a support that comprises a central region and a plurality of recesses with edge chamfers surrounding the central region;
a display mounted in the support;
a gaze tracker in the support, wherein the gaze tracker comprises light emitters mounted on a printed circuit and light detectors, and each of the light emitters is mounted in a given one of the plurality of recesses; and
a plurality of lenses in the support, wherein each of the lenses comprises a peripheral edge that defines a lens footprint that entirely overlaps a footprint of the light emitters on the printed circuit.
